(19) United States
(12) Patent Application Publication
(10) Pub. No.: US 2007/0133604 A1
(43) Pub. Date: Jun. 14, 2007

(54) Virtual network adapter for automatically maximizing frame sizes and avoiding physical network IP fragmentation

(75) Inventors: Randall Scott Nelson, Rochester, MN (US); Eric Gene Thiemann, Hayfield, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/297,306

(22) Filed: Dec. 8, 2005

(51) Int. Cl. H04J 3/16

(52) U.S. Cl. 370/470

(57) ABSTRACT

A method, virtual network adapter and computer program product are provided for automatically maximizing frame sizes and avoiding physical network Internet Protocol (IP) fragmentation. A maximum frame size of a selected physical adapter is identified. A frame size for the virtual adapter is calculated using the identified maximum frame size of the selected physical adapter. The calculated frame size of the virtual adapter is reported to an operating system.

### FIELD OF THE INVENTION

The present invention relates generally to the storage and data networking fields, and more particularly, relates to a method, virtual network adapter and computer program product for automatically maximizing frame sizes and avoiding physical network Internet Protocol (IP) fragmentation.

### DESCRIPTION OF THE RELATED ART

As used in the present specification and claims, the term virtual network adapter should be understood to include a network adapter that uses a physical link of a physical adapter to transmit and receive frames over an IP based physical network.

Internet protocol (IP) has been defined to provide for transmitting blocks of data called internet datagrams from sources to destinations, where sources and destinations are hosts identified by fixed length addresses. The internet datagram is a unit of data including an internet header exchanged between the source and destination internet computer systems. The internet protocol implements two basic functions of addressing and fragmentation. The internet protocol is specifically limited in scope to provide the functions necessary to deliver a package of bits, the internet datagram, from a source to a destination over an interconnected system of networks.

The internet protocol (IP) provides for fragmentation and reassembly of long datagrams for transmission through small packet networks. If an IP datagram is too large to send as a single frame over a network, IP performs IP fragmentation on the IP datagram. IP uses predetermined fields in the internet protocol header to fragment and reassemble internet datagrams. IP resides in each host engaged in internet communication and shares common rules for interpreting address fields and for fragmenting and assembling internet datagrams.

IP fragmentation on the IP datagram breaks the IP datagram into smaller IP datagrams that can be sent over the network. IP fragmentation uses a fair amount of system resources, especially if a fragment is lost or dropped, and CPU cycles to reassemble an original datagram. It is best to avoid IP fragmentation when maximum performance is desired.

In the context of a virtual network adapter, a need exists for an effective mechanism for automatically maximizing frame sizes, and avoiding physical network Internet Protocol (IP) fragmentation, to provide improved performance.

### SUMMARY OF THE INVENTION

Principal aspect of the present invention are to provide a method, virtual network adapter and computer program product for automatically maximizing frame sizes and avoiding physical network Internet Protocol (IP) fragmentation. Other important aspects of the present invention are to provide such a method, virtual adapter and computer program product for automatically maximizing frame sizes and avoiding physical network Internet Protocol (IP) fragmentation substantially without negative effect and that overcome many of the disadvantages of prior art arrangements.

In brief, a method, virtual adapter and computer program product are provided for automatically maximizing frame sizes and avoiding physical network Internet Protocol (IP) fragmentation. A maximum frame size of a selected physical adapter is identified. A frame size for a virtual adapter is calculated using the identified maximum frame size of the selected physical adapter. The calculated frame size of the virtual adapter is reported to an operating system.

In accordance with features of the invention, the frame size of the virtual adapter is automatically adjusted to a maximum frame size corresponding to the maximum frame size of the selected physical adapter, so that the largest possible frames are allowed, while avoiding physical network Internet Protocol (IP) fragmentation. A performance benefit or improved performance is enabled using the maximum size frames, rather than a fixed small frame size to avoid physical network Internet Protocol (IP) fragmentation used in some conventional arrangements. The calculated frame size of the virtual adapter includes an adjustment for the header length of the physical network adapter's media access address (MAC) header, an internet protocol (IP) header, and each header and each trailer unique to the virtual adapter implementation.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for use with a virtual network adapter in accordance with the preferred embodiment;

FIG. 2 is a block diagram representation illustrating an exemplary virtual network adapter system for use with the computer system of FIG. 1 in accordance with the preferred embodiment;

FIG. 3 is a flow chart illustrating exemplary steps for implementing maximum frame size of the virtual network adapter and avoiding physical network Internet Protocol (IP) fragmentation on an underlying physical network adapter; and

FIG. 4 is a block diagram illustrating a computer program product in accordance with the preferred embodiment.

### DETAILED DESCRIPTION OF THE PREFERRED EMBODIMENTS

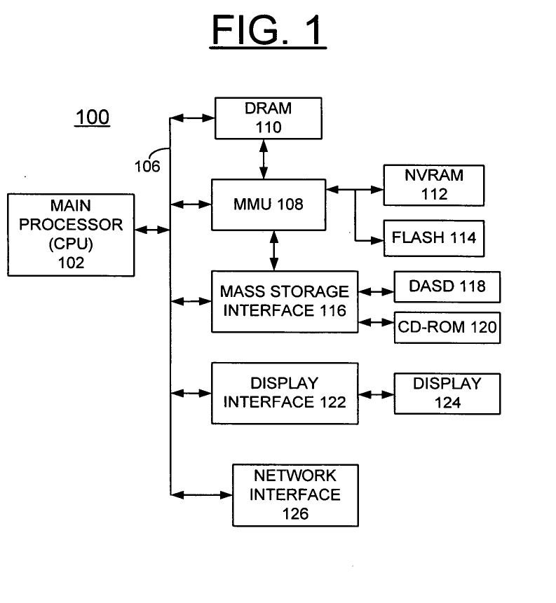

Having reference now to the drawings, in FIG. 1, there is shown a computer system generally designated by the reference character 100 for use with virtual network adapter in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors. Various commercially available computers can be used for computer system 100, for example, an IBM computer or server system.

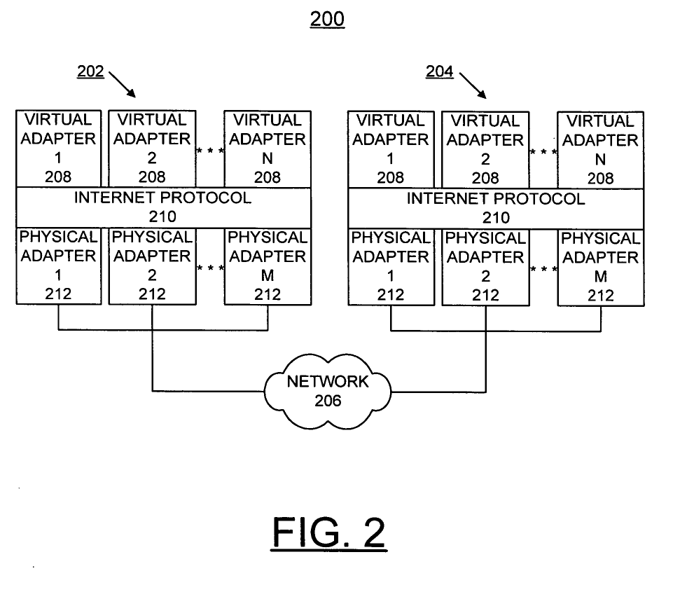

Referring now to FIG. 2, there is shown an exemplary virtual adapter network system generally designated by the reference character 200 for implementing methods for automatically maximizing frame size and avoiding physical network Internet Protocol (IP) fragmentation in accordance with the preferred embodiment. Virtual adapter network system 200 includes a first computer system 202 and a second computer system 204 connected to an IP based physical network 206. Each computer system 202, 204 includes a plurality of virtual adapters 1-N, 208 of the preferred embodiment, an Internet Protocol (IP) module 210, and a plurality of physical adapters 1-M, 212.

It should be understood that the present invention is not limited to the illustrated virtual network adapter system 200. For example, the number N of virtual adapters 208 and the number M of physical adapters 212 are not necessarily the same number. That is, there is not necessarily a one-to-one correspondence for a virtual adapter 208 to a physical adapter 212. For example, all the virtual adapters 1-N, 208 could use the same physical adapter 212.

In accordance with features of the invention, each virtual adapter 208 automatically adjusts its maximum frame size corresponding to the maximum frame size of the selected underlying physical adapter 212. The largest possible frames are allowed for virtual adapters 208, while physical network Internet Protocol (IP) fragmentation is avoided. IP fragmentation can occur when adding required network headers and trailers causes the resultant physical frame to exceed the maximum frame size of the underlying physical adapter 212. The method of the invention enables improved performance by using the maximum size frames, rather than a fixed smaller frame size that are typically used in some conventional arrangements to avoid IP fragmentation.

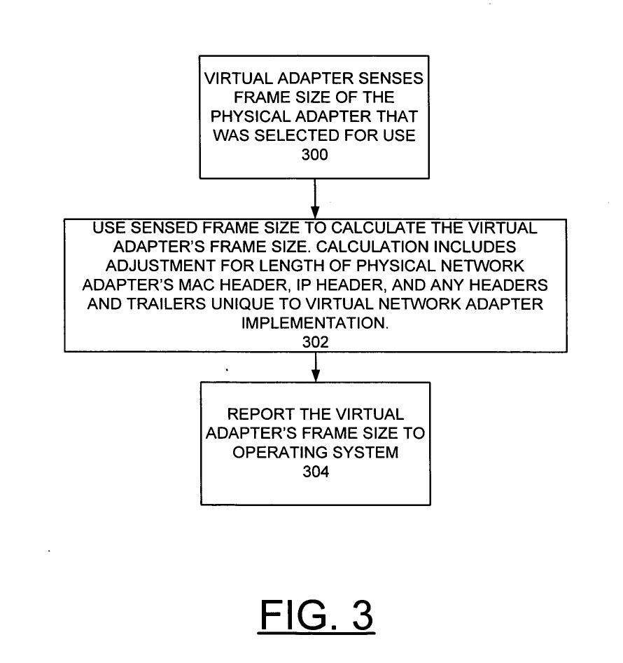

Referring now to FIG. 3, there is shown a flow chart illustrating exemplary steps for automatically maximizing frame size and avoiding physical network Internet Protocol (IP) fragmentation in accordance with the preferred embodiment. First, the virtual adapter senses a maximum frame size that is supported by a selected or underlying physical adapter as indicated in a block 300. A maximum frame size for the virtual adapter is calculated using the identified maximum frame size of the selected underlying physical adapter as indicated in a block 302. As shown at block 302, the calculation includes adjustment for header and trailer length including the physical network adapter's media access address (MAC) header, an internet protocol (IP) header, and each header and each trailer unique to the virtual adapter implementation. Then the virtual adapter reports the calculated frame size of the virtual adapter to an operating system as indicated in a block 304.

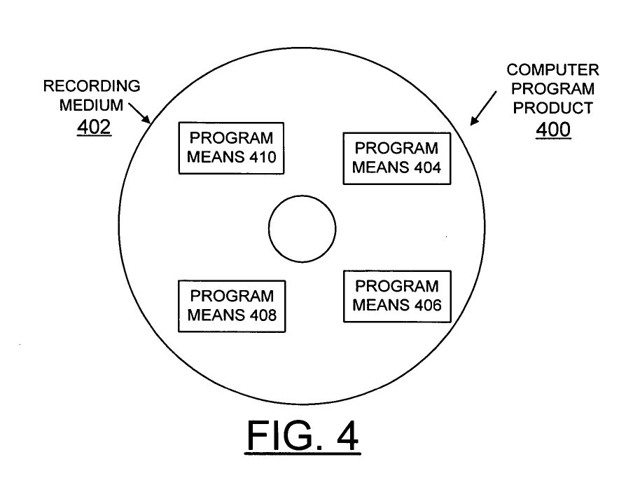

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for automatically maximizing frame size of the preferred embodiment in the system 200 of FIG. 2.

A sequence of program instructions or a logical assembly of one or more interrelated modules defined by the recorded program means 404, 406, 408, 410, direct the virtual adapter system 200 for implementing maximum frame size and avoiding physical network Internet Protocol (IP) fragmentation of the preferred embodiment.

While the present invention has been described with reference to the details of the embodiments of the invention shown in the drawing, these details are not intended to limit the scope of the invention as claimed in the appended claims.

What is claimed is:

1. A method for automatically maximizing frame sizes and avoiding physical network Internet Protocol (IP) fragmentation with a virtual adapter used with a physical adapter to transmit and receive frames from an IP based physical network, said method comprising the steps of:
identifying a maximum frame size of a selected physical adapter;
calculating a frame size for the virtual adapter using said identified maximum frame size of the selected physical adapter; and
reporting said calculated frame size of the virtual adapter to an operating system.

2. A method for automatically maximizing frame sizes as recited in claim 1 wherein calculating said frame size for the virtual adapter includes identifying an adjustment header length.

3. A method for automatically maximizing frame sizes as recited in claim 2 wherein identifying said adjustment header length includes identifying a length of media access address (MAC) header of the physical network adapter, and an internet protocol (IP) header.

4. A method for automatically maximizing frame sizes as recited in claim 2 wherein identifying said adjustment header length includes identifying a length for each header and each trailer unique to the virtual adapter.

5. A method for automatically maximizing frame sizes as recited in claim 1 wherein identifying a maximum frame size of a selected physical adapter includes the virtual adapter sensing a maximum frame size of a selected physical adapter.

6. A computer program product for implementing automatic maximizing of frame sizes of a virtual adapter and avoiding physical network Internet Protocol (IP) fragmentation in a virtual adapter network system including a physical adapter for transmitting and receiving frames from an IP based physical network, said computer program product including instructions executed by the virtual adapter network system to cause the virtual adapter network system to perform the steps of:
identifying a maximum frame size of a selected physical adapter;
calculating a frame size for the virtual adapter using said identified maximum frame size of the selected physical adapter; and
reporting said calculated frame size of the virtual adapter to an operating system.

7. A computer program product for implementing automatic maximizing of frame sizes as recited in claim 6 wherein calculating said frame size for the virtual adapter includes identifying an adjustment header length.

8. A computer program product for implementing automatic maximizing of frame sizes as recited in claim 7 wherein identifying said adjustment header length includes identifying a header length of media access address (MAC) header of the physical network adapter, and an internet protocol (IP) header.

9. A computer program product for implementing automatic maximizing of frame sizes as recited in claim 7 wherein identifying said adjustment header length includes identifying a length for each header and each trailer unique to the virtual adapter.

10. A computer program product for implementing automatic maximizing of frame sizes as recited in claim 6 wherein identifying a maximum frame size of a selected physical adapter includes sensing a maximum frame size of a selected physical adapter.

11. A virtual adapter for automatically maximizing frame sizes and avoiding physical network Internet Protocol (IP) fragmentation, a selected physical adapter used with the virtual adapter to transmit and receive frames over an IP based physical network, the virtual adapter performing the steps of:
identifying a maximum frame size of said selected physical adapter;
calculating a frame size for the virtual adapter using said identified maximum frame size of the selected physical adapter; and
reporting said calculated frame size of the virtual adapter to an operating system.

12. A virtual adapter for automatically maximizing frame sizes as recited in claim 11 wherein identifying a maximum frame size of said selected physical adapter includes the virtual adapter sensing a maximum frame size of said selected physical adapter.

13. A virtual adapter for automatically maximizing frame sizes as recited in claim 11 wherein calculating a frame size for the virtual adapter using said identified maximum frame size of the selected physical adapter includes identifying an adjustment header length.

14. A virtual adapter for automatically maximizing frame sizes as recited in claim 13 wherein identifying said adjustment header length includes identifying a length of media access address (MAC) header of the physical network adapter, and an internet protocol (IP) header.

15. A virtual adapter for automatically maximizing frame sizes as recited in claim 13 wherein identifying said adjustment header length includes identifying a length for each header and each trailer unique to the virtual adapter.
